(19) United States
(12) Patent Application Publication
(10) Pub. No.: US 2019/0060967 A1
(43) Pub. Date: Feb. 28, 2019

(54) VERSATILE CLEANING IMPLEMENTS

(71) Applicant: William Cody Fairbanks, Sandy, UT (US)

(72) Inventor: William Cody Fairbanks, Sandy, UT (US)

(21) Appl. No.: 16/110,977

(22) Filed: Aug. 23, 2018

Related U.S. Application Data
(60) Provisional application No. 62/549,428, filed on Aug. 24, 2017.

(51) Int. Cl. B08B 9/08; A47L 17/06; A47L 17/10; A47L 17/08; A46B 15/00; B08B 1/00

(52) U.S. Cl. CPC B08B 9/0808; A47L 17/06; A47L 17/10; A47L 17/08; A46B 2200/3006; B08B 1/002; B08B 1/005; B08B 1/006; A46B 15/0081

(57) ABSTRACT

Cleaning implement for cleaning objects such as dishes, glassware, utensils, appliances, and other objects as well as methods for manufacture and use thereof. A cleaning implement can include a first support structure having a proximate end and a distal end, a first cleaning surface coupled to a first side of the first support structure. The cleaning implement can include a second cleaning surface coupled to a second side of the first support structure, the first side of the first support structure being opposite to the second side of the first support structure. The cleaning implement can include a second support structure having a proximate end and a distal end, the proximate end of the second support structure being pivotally connected to the proximate end of the first support structure. The cleaning implement can include a third cleaning surface coupled to a side of the second support structure.

### CROSS-REFERENCE TO RELATED APPLICATIONS

This application claims the benefit of and priority to U.S. Provisional Patent Application 62/549,428 filed Aug. 24, 2017, the contents of which are incorporated herein by reference in its entirety.

### BACKGROUND OF THE INVENTION

Cleaning of dishes, utensils, glasses, kitchen appliances, and containers using conventional hand held scrub brushes, sponges, and pads such as those shown in FIGS. 1 and 1B can be laborious and time consuming. Such traditional cleaning implements are limited in their application and utility. For example, the traditional scrub brush has an inherent limitation in that it is defined by a single brush size and shape. Moreover, the length at which the brush is held relative to the handle is fixed. The brush is limited to a single scrubbing surface at any one time. And, the angle and orientation of the brush itself relative to the handle is also fixed. For example, as illustrated in FIG. 1A, a traditional scrubbing brush is illustrated. This traditional scrub brush can only clean one side or surface of an object at a time. More specifically as shown in FIG. 1A the traditional scrub brush is limited to cleaning a single side of a kitchen knife at a time.

Referring to FIG. 1B, a traditional scrub brush and sponge are shown in an attempt to clean the interior surface of glassware. As shown, it is only possible for the sponge to clean an uppermost rim of the interior surface of the glass better-yet the bottom of the interior of the class. Thus, neither the traditional scrub brush nor the traditional sponge is able to properly clean the interior of the glass as shown in FIG. 1B. And, none of the aforementioned cleaning implements make it easy to reach into the interior surface of the glassware, remotely possible to clean the deepest bottom surface of the glass or other container, or simultaneously clean opposing surfaces of the knife, glass or other object.

The cleaning implements according to the teachings disclosed hereinafter can also alleviate the need for multiple different cleaning devices. For example a common collection of kitchen cleaning brushes, sponges, and other cleaning tools as shown in FIGS. 1A and 1B are often collected, used, scattered, lost, and accumulated for various different purposes. None of these multiple tools individually, or collectively, provide the ease of use and efficiency of various cleaning implement designs as discussed hereinafter and illustrated in the drawings.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF THE INVENTION

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A cleaning implement can include a first support structure having a proximate end and a distal end, a first cleaning surface coupled to a first side of the first support structure, a second cleaning surface coupled to a second side of the first support structure, the first side of the first support structure being opposite to the second side of the first support structure, a second support structure having a proximate end and a distal end, the proximate end of the second support structure being pivotally connected to the proximate end of the first support structure, and a third cleaning surface coupled to a side of the second support structure such that in a folded position of the first and second support structure the second and third cleaning surfaces are disposed on opposing surfaces of an object being cleaned.

The cleaning implement can be reconfigurable to an elongated position such that the first support structure is substantially in-line with the second support structure thereby approximately doubling the depth to which the third cleaning surface may access the interior of an object. The third cleaning surface can be pivotally coupled to the second support structure so as to enable the third cleaning surface to pivot and clean a perpendicular bottom surface of the object.

The cleaning implement can include an appendage extending from the first support structure for scraping material and the appendage for scraping material can be disposed between the first and second cleaning surfaces.

The third cleaning surface can be attached to the second support structure by a pivotable joint. And, the third cleaning surface can be pivotable between a substantially parallel position relative to the second support structure to a substantially perpendicular position relative to the second support structure.

The first and second cleaning surfaces can be disposed opposite to each other for simultaneously cleaning of opposing surfaces. A pinching pressure applied to the first and second support structures provides opposite biasing pressure to the first and second cleaning surfaces against opposing surface of an object. The first cleaning surface can be a brush and the second cleaning surface can be a cleaning pad or sponge. The third cleaning surface can be a cleaning pad or sponge.

The second and third cleaning surfaces can be smaller in size to the first cleaning surface. The second and third cleaning surfaces are sized for cleaning the interior of a drinking glass or vase while the first cleaning surface is sized too large to clean the interior of the drinking glass or vase.

A method of cleaning an object using a cleaning implement can include providing the cleaning implement in any form as set forth herein. The method can include simultaneously cleaning opposing surfaces of the object using the second and third cleaning surfaces. The method can include pivoting the first support structure relative to the second support structure from a folded position to an unfolded position thereby extending the reach of the third cleaning surface within an interior of the object. The third cleaning surface being pivotally connected to the second support structure so as to rotate between a parallel position relative to the second support structure and a perpendicular position relative to the second support structure. The method can include cleaning a vertical interior sidewall of the object in the parallel position. The method can include cleaning a bottom interior surface of the object in the perpendicular position.

The method can include rotating the cleaning implement and using the first cleaning surface in the form of a brush so as to clean relatively large surfaces of the object, wherein the first cleaning surface is too large to clean interior surfaces of the object.

The method can include using a cleaning implement where the second and third cleaning surfaces including connectors for interchangeably connecting the second and third cleaning surfaces to the first and second support structures respectively, the method further comprising replacing the second and third cleaning surfaces.

Methods of manufacturing such cleaning implements can include selection of the size of the cleaning surfaces based on the dimensions of the objects for cleaning.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a scrub brush cleaning a kitchen knife according to the prior art;

FIG. 1B illustrates the scrub brush and a sponge cleaning a drinking glass according to the prior art;

FIG. 2 illustrates a cleaning implement according to an embodiment of the present invention;

FIG. 3 illustrates a cleaning implement simultaneously cleaning opposing surfaces of a spatula according to an embodiment of the present invention;

FIG. 4 illustrates a cleaning implement simultaneously cleaning opposing surfaces of a kitchen knife according to an embodiment of the present invention;

FIG. 5 illustrates a cleaning implement simultaneously cleaning opposing sides of utensils according to an embodiment of the present invention;

FIG. 6 illustrate a cleaning utensil and actuation of opposing cleaning brushes simultaneously cleaning opposing surface of a drinking glass;

FIG. 7 illustrates a collapsed or folded form of the cleaning utensil illustrating the size and reach in such position;

FIG. 8 illustrates an unfolded extended position of the cleaning utensil as well as a pivotable cleaning head of the cleaning utensil;

FIG. 9 illustrates an extended reach and pivoted position of the cleaning surface within a drinking glass or other container; and

FIG. 10 illustrates a detachable and replaceable scrubbing surface for replacement in a kit or other supply.

### DETAILED DESCRIPTION OF SEVERAL INVENTIVE EMBODIMENTS

The present invention provides for innovative cleaning implements. The cleaning implements can include a plurality of scrubbing surfaces for simultaneous or individual cleaning of a dish, glassware, container, object, or appliance, for example. The scrubbing surfaces can be affixed to multiple support structures and the support structures can be pivotally affixed to one another so as to enable multiple different cleaning configurations. According to the teachings disclosed herein by the named inventor the cleaning implement can include multiple scrubbing and/or cleaning surfaces. These multiple scrubbing surfaces can be disposed opposite to one another on facing supports to simultaneously clean multiple opposing surfaces at the same time thereby substantially reducing the amount of time spent individually cleaning each surface. Different sized cleaning surfaces may be disposed for cleaning differently accessible or constrained surfaces. For example, where two surfaces of a dish, utensil, container, or other object are simultaneously cleaned, the total time spent may be reduced in half.

According to various embodiments disclosed herein the cleaning implement can be reconfigurable so as to expand the available cleaning distance between support surfaces and a handle. In some instances the expandability of the cleaning implement can almost double the distance at which an interior surface may be reached and cleaned by the scrubbing and cleaning surfaces of the implement.

In some embodiments, the cleaning implement can have cleaning and scrubbing surfaces of different attributes. The different attributes may be size or cleaning attributes such as a brush, scrub pad, or sponge. For example, one support surface may include a relatively large scrubbing surface while another support surface may have a relatively small scrubbing surface. The relatively small scrubbing surface can allow for the cleaning surface of the implement to reach into a relatively narrow and deep container or glassware. Other examples of containers particularly suited for such a cleaning implement according to the teachings herein include long and narrow vase, outdoor drink container, or other object with similar restrictions on the available interior space for reaching the surfaces therein. The cleaning implement may also have a relatively larger cleaning surface such as a brush for cleaning a larger accessible surface such as the cooking surface of a pot or skillet along with a relatively narrow cleaning surface better suited for cleaning within a narrow container or simultaneously with the relatively larger brush cleaning the exterior surface.

As previously discussed the cleaning implement may be in a folded configuration where opposing surface of a utensil, glass, plate, pot, or other object can be pinched between cleaning surfaces of the implement to simultaneously clean the opposing surface of the object thereby reducing the traditional time required to clean the object in half. Then, the folded supports of the cleaning implement may be unfolded by a pivotable joint there between so as to extend the available reach of a cleaning surface for accessing a relatively narrow interior surface. The cleaning implement can be easily folded to the collapsed position of the cleaning implement and unfolded into the expanded position of the implement easily and quickly even using a single hand so as to rapidly clean a multitude of different objects with different shapes, sizes, and surfaces.

According to various embodiments, a cleaning surface may be pivotally attached to a support structure so as to be able to pivot from a first position in a direction parallel to an axis or direction of extension of a support structure connected thereto into a position that may extend 45 degrees, perpendicular or more relative to the direction of extension of the support structure. This direction may also be relative to a center axis of a container such as a vase, glass, or insulated container. For example, a centerline of the container may be parallel to a direction of extension of the interior cylindrical walls of a container. The first position of the cleaning surface may be parallel to this interior wall and central axis of the object so as to clean the interior walls of a relatively narrow, in some instances, container or glass. Then, the cleaning surface may be pivoted about the support structure using a flexible joint made of rubber, silicone, relatively narrow plastic, or pivot so as to pivot the cleaning surface at an angle to the support structure as discussed and shown in further detail in reference to FIG. 9.

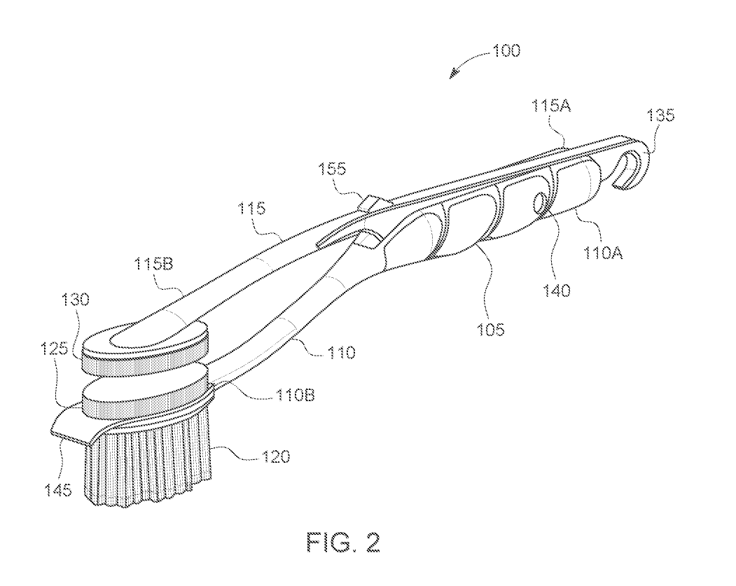

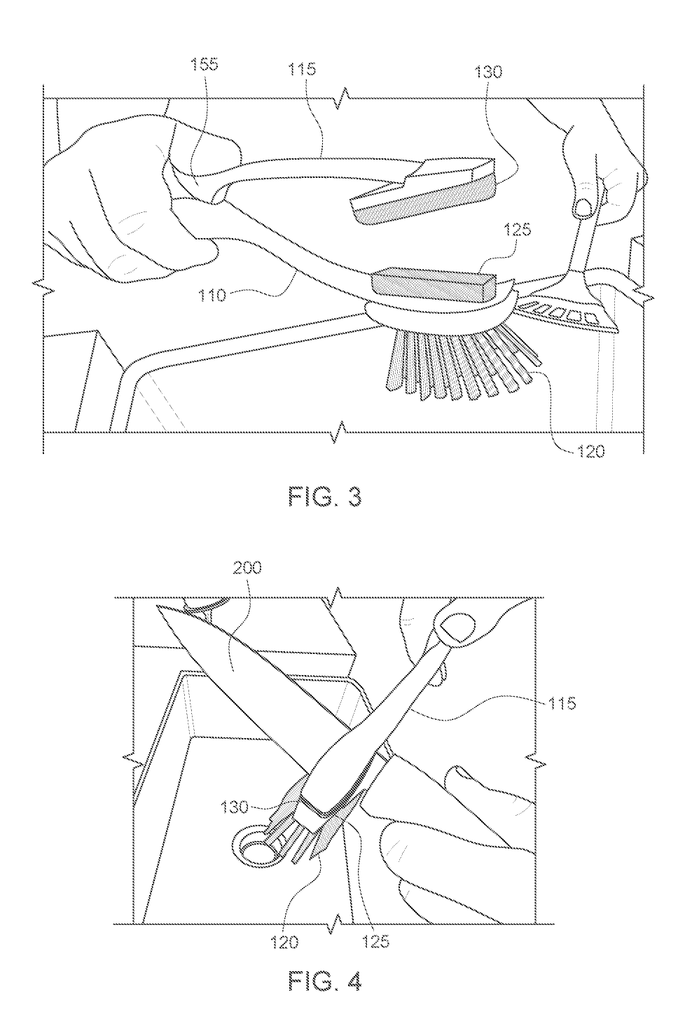

FIGS. 2 and 3 illustrate an embodiment of the cleaning implement 100 according to an embodiment of the invention. The cleaning implement 100 includes a handle 105 connected to a first support structure 110. The first support structure 110 having a proximate end 110A proximate to the pivotable joint and a distal end 110B. The first support structure 110 includes a first cleaning surface 120 in the form of a scrub brush disposed near the distal end 110B of the first support structure 110. The scrub brush 120 is relatively large and is disposed upon a first outwardly facing side of the first support structure 110 so as to face away from the first support structure 110. The scrub brush 120 is disposed at, or near, the distal end 110B of the first support structure 110. A proximate end 110A of the first support structure 110 can be connected to or forming part of the handle 105 as illustrated in FIG. 2.

The first support structure 110 further comprising a second side having a second cleaning surface 125 disposed thereon. The first cleaning surface 120 being extending from the distal end 110B of the first support structure 110 in a direction opposite to the second cleaning surface 125. The second cleaning surface 125 can be a second brush, sponge, pad, mesh, metallic or plastic pad, or other type of cleaning surface.

The handle 105 can include a connector 135 in the form of a hook as shown. Other connectors 135 can include a hole, or string, for hanging or connecting the cleaning implement to a fixture (not shown). The fixture can be a hook disposed on a wall or interior surface of a door or cabinet. At an opposite end of the first support structure 110 an additional scrapping and cleaning appendage 145 may be provided as shown in FIG. 2. The scrapping and cleaning appendage 145 may be relatively rigid and formed of a plastic material for scraping or scrubbing debris from a surface.

The handle 105 and first support structure 110 are pivotally connected to the second support structure 115 by a pivoted joint 140 such as a rivet, pin, joint, or other rotatable feature. This pivotable joint 140 allows for reconfiguration of the cleaning implement 100 replacing the need for multiple different cleaning tools of individually different sizes and cleaning capabilities. The second support structure 115 has a proximate end 115A pivotally connected to the first support structure 110. The second support structure 115 extending from its proximate end 115A to the distal end 115B of the second support structure 115 where a third cleaning surface 130 is disposed. The third cleaning surface 130 can include a scrub brush, sponge, or other cleaning surface. The third cleaning surface 130 can be disposed on the second support structure 115 so as to be disposed opposite to the second cleaning surface 125 supported by the first support structure 110. As shown the second cleaning surface 125 and third cleaning surface 130 are disposed opposite to one another so as to simultaneously clean opposing surfaces of a dish, utensil, or container. For example, during use the first support structure 110 and second support structure 115 may be biased toward each other (e.g. pinched together) so as to simultaneously clean opposing surfaces of a dish, container, glass, utensil, knife, or other object.

The first support structure 110 can include an appendage 155 for manual articulation of the first support structure 110 relative to the second support structure 115 so as to increase and decrease the separation between the second cleaning surface 125 and third cleaning surface 130. This manual articulation of the relative pivotal positions of the first support structure 110 relative to the second support structure 115 is also used so as to apply an appropriate positioning and pinching pressure to the spatula, knife, utensil, dish, container, or object. The support structures 115 and 110 may be semi-flexible where they are held a distance apart and manually bent so as to engage or apply an appropriate pressure from the second and third cleaning surfaces 125 and 130 to opposing surfaces of the spatula, knife, utensil, dish, container, or other object.

The appendage 155 can also be a position lock where sliding the appendage 155 engages a mechanical hook or internal lock so as to lock structures 110 and 115 relative to one another. For example, the support structures 110 and 115 can be squeezed to bias support structure 110 toward support structure 115 so as to press cleaning surface 125 against cleaning surface 130. In such position the locking appendage 115 may be slid or otherwise moved toward the distal end of support 115 so as to engage the locking mechanism, hold the cleaning surfaces 125 and 130 together in a stored configuration such that the structures do not pivot relative to one another when in the locked position.

For example, referring to FIG. 3 the cleaning implement 100 is shown in use in cleaning a spatula. The spatula is held between the second cleaning surface 125 and third cleaning surface 130 thereby simultaneously cleaning opposing surfaces of the spatula. The cleaning implement 100 is held by the handle (not shown) and the second cleaning surface 125 and third cleaning surface 130 are pinched against opposing surfaces of the spatula while the opposing surfaces of the knife 200 are simultaneously cleaned as shown. The cleaning implement 100 can be rotated in-hand so as to use the first cleaning surface 120 of the cleaning implement 100 similar to that of a traditional scrub brush as well.

Referring to FIG. 4 the cleaning implement 100 is shown in use in cleaning a kitchen knife 200. The kitchen knife 200 is held between the second cleaning surface 125 and third cleaning surface 130 thereby simultaneously cleaning opposing surfaces of the kitchen knife 200. The cleaning implement 200 is held by the handle (not shown) and the second cleaning surface 125 and third cleaning surface 130 are pinched against opposing surfaces of the knife 200 while the opposing surfaces of the knife 200 are simultaneously cleaned as shown. The cleaning implement 100 can be rotated in-hand so as to use the first cleaning surface 120 of the cleaning implement 100 similar to that of a traditional scrub brush as well.

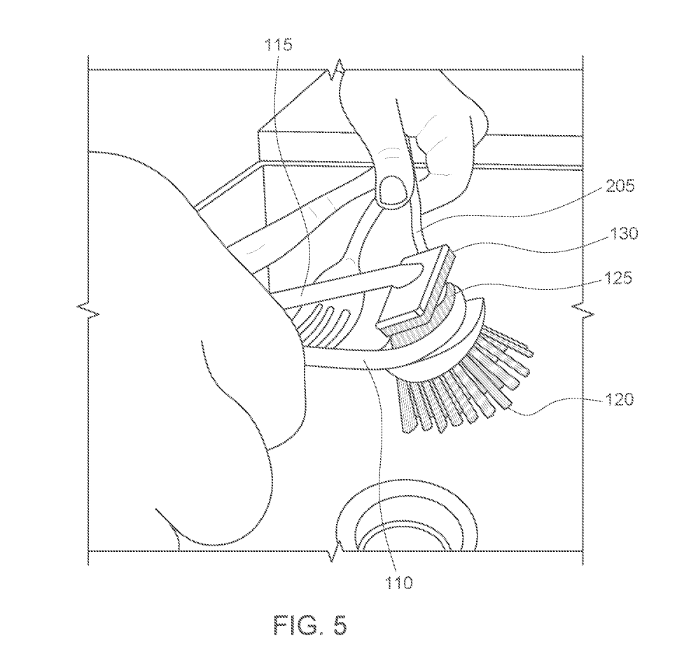

Referring to FIG. 5 the cleaning implement 100 is shown in use in cleaning a utensil 205. The utensil 205 is held along with other utensils (fork and knife) between the second cleaning surface 125 and third cleaning surface 130 thereby simultaneously cleaning opposing surfaces of the utensil 205. The cleaning implement 200 is held by the handle (not shown) and the second cleaning surface 125 and third cleaning surface 130 are pinched against opposing surfaces of the utensil 205 while the opposing surfaces of the utensil 205 are simultaneously cleaned as shown. The cleaning implement 100 can be rotated in-hand so as to use the first cleaning surface 120 of the cleaning implement 100 similar to that of a traditional scrub brush as well.

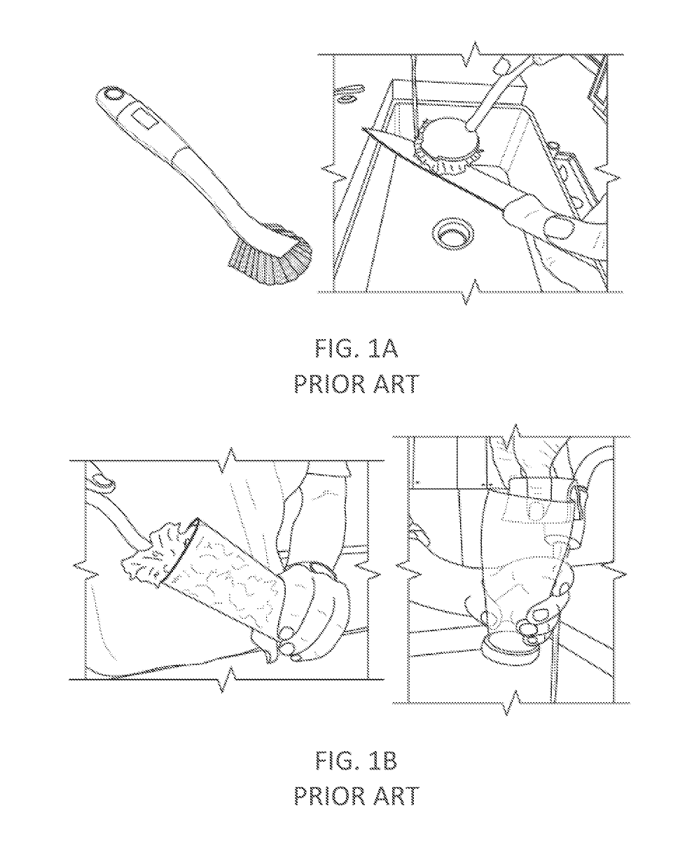

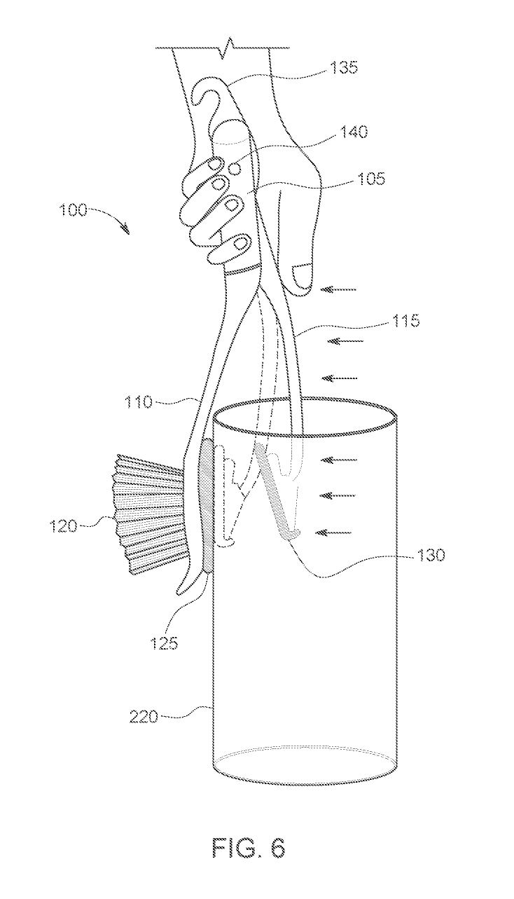

As illustrated in FIGS. 3-5, the ability to use the second cleaning surface 125 and opposing third cleaning surface 130 is enabled without interference from the first cleaning surface 120 including the relatively large scrubbing brush. For example, referring to FIG. 6 the cleaning implement 100 is shown simultaneously cleaning the inside and outside of a drinking glass 220 while the first cleaning surface 120 is disposed on an opposite side of the support structure 110 from the cleaning surface 125 and does not interfere with cleaning the interior and exterior surface of the glass 220. In the example of FIG. 6, the drinking glass 220 being cleaned is a relatively narrow glass where the size of the third cleaning surface is relatively small so as to fit within this relatively small interior diameter of the champagne glass as shown and as compared to the traditional limitations previously illustrated in FIG. 1B.

While a traditional sponge may have been used to clean a glass as shown in FIG. 1B, the sponge is only able to clean the rim of the glass as shown. The cleaning implement 100 as disclosed herein and shown in FIG. 6 is able to simultaneously clean the entire interior and exterior of the glass 220 as shown in FIG. 6. Rather, the cleaning surfaces 125 and 130 simultaneously clamp down on both sides of the wall of the drinking glass 220 and simultaneously cleaning the interior and exterior surfaces of the drinking glass 220.

As shown by arrows in FIG. 6, the support structure 115 and cleaning surface 130 may be held a small distance from support structure 110 and cleaning surface 125 in a relaxed state. The support structure 115 and cleaning surface 130 may be urged toward support structure 110 and cleaning surface 125 by squeezing them toward one another. The natural or relaxed position between the support structure 115 and cleaning surface 130 relative to support structure 110 and cleaning surface 125 may be maintained by a spring or other biasing feature. The natural or relaxed position between the support structure 115 and cleaning surface 130 relative to support structure 110 and cleaning surface 125 may be maintained by the manufactured shape of the support structures 110 and 115 where the support structures may be bent toward one another so as to engage the cleaning surfaces 130 and 125 with the interior and exterior surfaces of the glassware 220, for example. For example, a rainbow shaped spring (not shown) may be disposed within the handle 105 and between the support structures near the handle 105 so as to urge the support structures 110 and 115 relative to one another. As previously discussed, a locking mechanism may be used to retain the closed position of support structures 110 and 115 relative to one another.

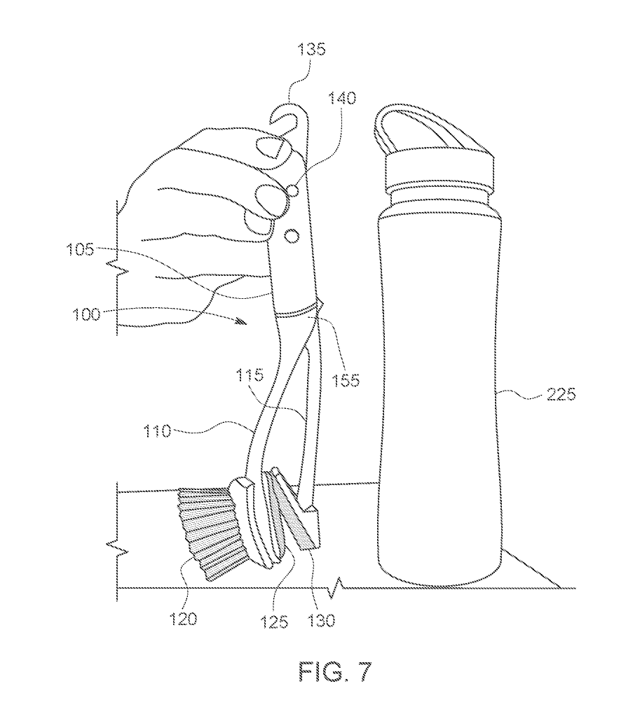

According to another advantage of the cleaning implements 100 disclosed herein regards substantially deep and narrow glasses and containers 225 such as illustrated in FIG. 7. In this example, the container 225 is approximately ten (10) inches deep and the length of the second support structure 115 may only reach approximately eight (8) inches deep in the folded configuration shown in FIG. 7.

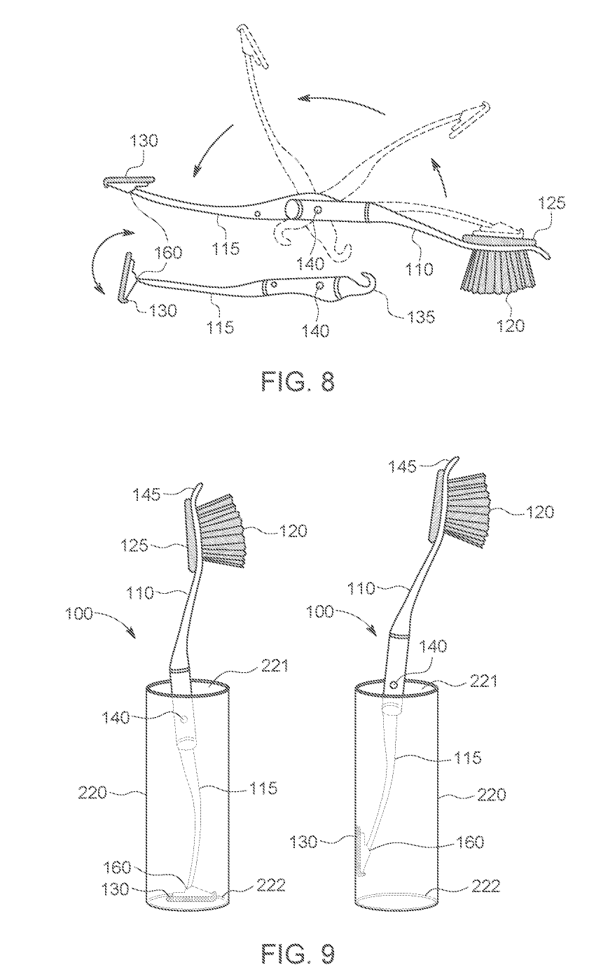

However, the cleaning implement 100 is configured to essentially double the length of the effective support due to the pivotal coupling 140 rotatably joining the first support structure 110 to the second support structure 115 as illustrated in FIG. 8. That is, the first support structure 110 can be pivoted via the pivotable joint 140 relative to the second support structure 115 from a folded position shown in FIGS. 2-7 to an elongated and unfolded position shown in FIGS. 8 and 9. That is, where the first support structure 110 is folded relative to the second support structure 115 in an adjacent position as shown in FIGS. 2-7, the first support structure 110 can be unfolded and extended away from the second support structure 115 according to the pivotal connection 140 there between so as to be disposed substantially in-line with the second support structure 115 as shown in FIGS. 8 and 9. As such, a somewhat single substantially elongated support structure (110 and 110 disposed in-line) including the collective lengths of the first support structure 110 and the second support structure 115 and handle 105 may be used to reach the interior of a relatively deep glass 220 or other container, object, or appliance.

To more easily transition from the folded configuration to the unfolded elongated configuration another articulation appendage such as the connection appendage 135 can be connected to an end of the first or second support structure as illustrated in FIGS. 7 and 8 in the form of the hook and used to articulate the cleaning appliance 100 from the folded positon shown in FIGS. 2-7 and into the unfolded position shown in FIGS. 8 and 9. This articulation appendage 135 can be manually manipulated so as to pivot the first and second support structures relative to one another, for example, using a finger in a matter of a second or less so as to reconfigure the cleaning implement 100 to clean the sports bottle 225 or glass as shown in FIG. 9. Cleaning even a narrow plant vase or otherwise previously impossible similar container becomes possible using the cleaning implement disclosed herein as illustrated in FIG. 9 with approximately 18 inches of collective support length to reach even the longest and thinnest of dishes, containers, appliances, and other objects.

One or more cleaning surfaces of the cleaning implement can be pivotally connected to the support structures. For example, a problem arises as to how to clean the deepest bottom surface of the interior of a container shown in FIG. 9. As shown in FIGS. 8 and 9 the third cleaning surface 130 can have a pivotable connection 160 to the second support structure 115 so as to pivot from a parallel position from which the sides 221 of the interior of the container or glass 220 are cleaned to a perpendicular position from which the bottom 222 of the interior of the container or glass 220 is cleaned. That is, the third cleaning surface 130 is pivotably connected to the second support structure 115 so as to pivot from a substantially parallel position shown on the right in FIG. 9 to clean in the interior sidewalls 221 of the glass 220 to a substantially perpendicular position shown on the left in FIG. 9 to clean the interior bottom 222 of the drinking glass 220 as shown in FIG. 9. Thus, the third cleaning surface 130 and second support structure 115 can have a parallel configuration and a perpendicular configuration relative to one another due to a flexible and pivotable connection 160 disposed there between as shown in FIGS. 8 and 9. The pivotal connection 160 can include a substantially bendable rubber, silicone, joint, or other material connection between the second support structure 115 and the third cleaning surface 130 as illustrated in FIGS. 8 and 9. The connection between the second support structure 115 and the third cleaning surface 130 can be normally held in the parallel state whereas the third cleaning surface 130 may be manually urged into the perpendicular state or at any angle there between so as to return to its materially natural state in the parallel position as illustrated in FIGS. 2-7.

The first cleaning surface 120 in the form of a more traditional scrub brush is available at all times so as to use the relatively larger and longer bristles thereof by repositioning the handle of the cleaning implement 100. The versatility of the cleaning implement 100 can be used to clean objects beyond dishes, utensils, and containers such as appliances where the cleaning utensil 100 may be used so as to clean the interior of a coffee maker, for example. Other examples of objects that find the versatility of the cleaning implement advantageous can include the cleaning of a humidifier or even items and objects in a shop vacuum, fish tank, automobile, or garage.

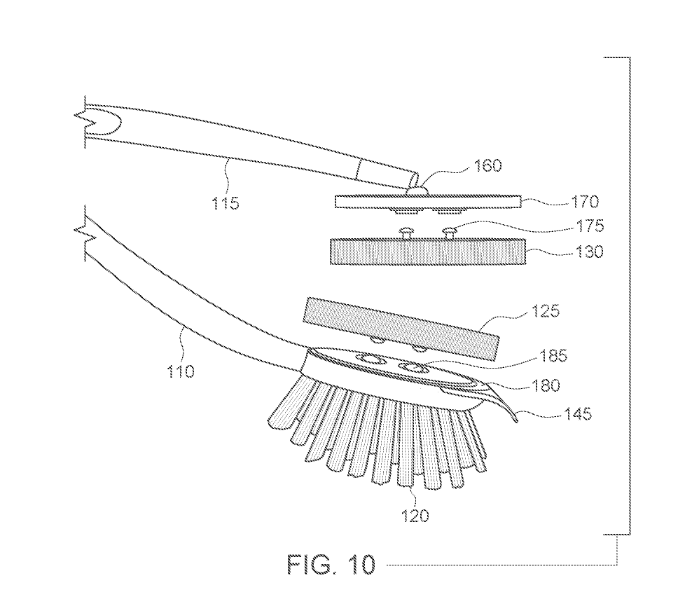

FIG. 10 illustrate interchangeable or replacement cleaning surfaces 125 and 130 which may be provided as part of a kit with multiple replaceable cleaning surfaces 125 and 130. The cleaning surfaces 125 and 130 can be attached to a support 180 and 170 respectively. The supports 170 and 180 can have coupling features 185 and the cleaning surfaces 125 and 130 can have connectors 175. The connectors 175 may be male appendages that mate with female apertures 185 disposed in the support structures 170 an 180.

In one embodiment, the second and third cleaning surfaces may be 0.25 inch or less in thickness while the first cleaning surface is a brush of over 1 inch in thickness

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. While certain functions have been recited such means for performing those functions are expressly supplied by such structure for mean-plus-function claims.

What is claimed is:

1. A cleaning implement comprising:
a first support structure having a proximate end and a distal end;
a first cleaning surface coupled to a first side of the first support structure;
a second cleaning surface coupled to a second side of the first support structure, the first side of the first support structure being opposite to the second side of the first support structure;
a second support structure having a proximate end and a distal end, the proximate end of the second support structure being pivotally connected to the proximate end of the first support structure; and
a third cleaning surface coupled to a side of the second support structure such that in a folded position of the first and second support structure the second and third cleaning surfaces are disposed on opposing surfaces of an object being cleaned.

2. The cleaning implement according to claim 1, wherein the cleaning implement is reconfigurable to an elongated position such that the first support structure is substantially in-line with the second support structure thereby approximately doubling the depth to which the third cleaning surface may access the interior of an object.

3. The cleaning implement according to claim 1, wherein the third cleaning surface is pivotally coupled to the second support structure so as to enable the third cleaning surface to pivot and clean a perpendicular bottom surface of the object.

4. The cleaning implement according to claim 1, further comprising an appendage extending from the first support structure for scraping material.

5. The cleaning implement according to claim 5, wherein the appendage for scraping material is disposed between the first and second cleaning surfaces and extending from the first and second cleaning surfaces.

6. The cleaning implement according to claim 1, the third cleaning surface being attached to the second support structure by a pivotable joint.

7. The cleaning implement according to claim 6, wherein the third cleaning surface is pivotable between a substantially parallel position relative to the second support structure to a substantially perpendicular position relative to the second support structure.

8. The cleaning implement according to claim 1, wherein the first and second cleaning surfaces are disposed opposite to each other for simultaneously cleaning of opposing surfaces.

9. The cleaning implement according to claim 8, wherein a pinching pressure applied to the first and second support structures provides opposite biasing pressure to the first and second cleaning surfaces against opposing surface of an object.

10. The cleaning implement according to claim 1, wherein the first cleaning surface is a brush and the second cleaning surface is a cleaning pad or sponge.

11. The cleaning implement according to claim 10, wherein the third cleaning surface is a cleaning pad or sponge.

12. The cleaning implement according to claim 11, wherein the second and third cleaning surfaces are smaller in size to the first cleaning surface.

13. The cleaning implement according to claim 12, wherein the second and third cleaning surfaces are sized for cleaning the interior of a drinking glass or vase while the first cleaning surface is sized too large to clean the interior of the drinking glass or vase.

14. A method of cleaning an object using a cleaning implement, comprising:
providing the cleaning implement including:
a first support structure having a proximate end and a distal end;
a first cleaning surface coupled to a first side of the first support structure;
a second cleaning surface coupled to a second side of the first support structure, the first side of the first support structure being opposite to the second side of the first support structure;
a second support structure having a proximate end and a distal end, the proximate end of the second support structure being pivotally connected to the proximate end of the first support structure; and
a third cleaning surface coupled to a side of the second support structure such that in a folded position of the first and second support structure the second and third cleaning surfaces are disposed on opposing surfaces of the object being cleaned; and
simultaneously cleaning opposing surfaces of the object using the second and third cleaning surfaces.

15. The method of cleaning an object using a cleaning implement according to claim 13, further comprising:
pivoting the first support structure relative to the second support structure from a folded position to an unfolded position thereby extending the reach of the third cleaning surface within an interior of the object.

16. The method of cleaning an object using a cleaning implement according to claim 14, the third cleaning surface being pivotally connected to the second support structure so as to rotate between a parallel position relative to the second support structure and a perpendicular position relative to the second support structure.

17. The method of cleaning an object using a cleaning implement according to claim 16, further comprising cleaning a vertical interior sidewall of the object in the parallel position.

18. The method of cleaning an object using a cleaning implement according to claim 17, further comprising cleaning a bottom interior surface of the object in the perpendicular position.

19. The method of cleaning an object using a cleaning implement according to claim 14, the second and third cleaning surfaces including connectors for interchangeably connecting the second and third cleaning surfaces to the first and second support structures respectively, the method further comprising replacing the second and third cleaning surfaces.

20. A method of manufacturing a cleaning implement, comprising:
selecting a size of a first cleaning surface, second cleaning surface, and third cleaning surface based on dimensions of an object to be cleaned by the cleaning implement, comprising:
selecting the size of the second and third cleaning surfaces based on a relatively constricted interior surface of the object; and
selecting the size of the first cleaning surface based on a relatively unconstructed exterior surface of the object;
manufacturing:
a first support structure having a proximate end and a distal end;
the first cleaning surface coupled to a first side of the first support structure;
the second cleaning surface coupled to a second side of the first support structure, the first side of the first support structure being opposite to the second side of the first support structure;
a second support structure having a proximate end and a distal end, the proximate end of the second support structure being pivotally connected to the proximate end of the first support structure; and
the third cleaning surface coupled to a side of the second support structure such that in a folded position of the first and second support structure the second and third cleaning surfaces are disposed on opposing surfaces of an object being cleaned.
